(19) United States
(12) Patent Application Publication
(10) Pub. No.: US 2008/0267081 A1
(43) Pub. Date: Oct. 30, 2008

(54) LINK LAYER LOOP DETECTION METHOD AND APPARATUS

(76) Inventor: Guenter ROECK, San Jose, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/109,035

(22) Filed: Apr. 24, 2008

Related U.S. Application Data
(60) Provisional application No. 60/914,548, filed on Apr. 27, 2007.

(51) Int. Cl. H04L 12/56; G06F 11/00

(52) U.S. Cl. 370/249; 370/401

(57) ABSTRACT

In one embodiment, a method includes receiving an indicator that an packet has been received at a physical port of a bridge device within a network. The method also includes determining, in response to the indicator and based on a source address value associated with the packet, that an identifier of the physical port is not associated within a filter database with the source address value. A packet counter value associated with the physical port is changed in response to the determining.

### CROSS REFERENCE TO RELATED APPLICATION

The present application claims the benefit of the commonly owned U.S. Provisional Patent Application No. 60/914,548, Attorney Docket No. TEAK-009/00US, entitled “Link Layer Loop Detection Method and Apparatus,” filed on Apr. 27, 2007, which is incorporated herein by reference in its entirety.

### FIELD OF THE INVENTION

The invention generally relates to the field of protocols and mechanisms for detecting computer network connectivity failures, and for preventing such failures from spreading through a network.

### BACKGROUND OF THE INVENTION

A computer network typically includes multiple computers connected together for the purpose of data communication. Large networks are typically divided by bridges and routers into network segments. The purpose of bridges and routers is the separation and isolation of individual parts of a network. As a result, available bandwidth for users of the network is increased.

Effectively, a bridge can be any network device with at least two network ports. Typical bridges can have 48 or more network ports. Basic bridge functionality is to receive frames on one port, to determine a destination port or ports, and to transmit the frames on the destination ports. A bridge typically connects network segments on Layer 2 (Data Link Layer) of the OSI Reference Model. In Ethernet, the functionality of a bridge is defined in IEEE Standard 802.1D, “Media Access Control (MAC) Bridges.” In the context of this standard, a network interconnected by bridges is called “Bridged Local Area Network.” Bridges are sometimes also called “Layer 2 switches.” Bridges are typically transparent to the users of a network.

In simple networks, network segments are typically connected to a single bridge, and there is no redundant communication path or link. More complex networks typically include redundant communication paths to prevent network segment isolation due to equipment or link failures, or to provide additional capacity for load balancing purposes. Such networks with redundant links typically require protocol support to prevent network loops from being formed. Such loops would cause individual data packets to re-circulate in the network, which would quickly saturate the network and cause severe connectivity problems for connected devices. A protocol to prevent network loops from being formed is called “Rapid Spanning Tree Protocol,” or RSTP. This protocol is defined in standard IEEE 802.1D, section 17. RSTP configures ports of interconnected bridges such that a network with redundant connections is converted into a tree structure. A predecessor of RSTP was Spanning Tree (STP), which is specified in section 4 of older versions of the IEEE802.1D standard.

A limitation of RSTP is that it can typically only detect and prevent network loops if the interconnecting bridges are configured correctly. Unfortunately, there are several conditions that can cause RSTP to fail. For example, a misconfiguration of Link Aggregation (Link Aggregation Control Protocol or LACP, standard IEEE802.3ad) may render network loops undetectable by RSTP. If a bridge involved in a loop does not support RSTP, the entire network can be at risk. Similarly, if a network device by default enables all ports, a loop could occur while the device is initializing itself, until RSTP detects the loop and disables individual ports.

Another limitation of RSTP is that it typically does not support load balancing and load sharing in meshed network architectures very well. Effectively, RSTP disables individual ports to form a non-meshed tree. Disabled ports and links are, as a consequence, not utilized, and serve as backup. As a result, overall throughput is reduced, and the data path may be unnecessarily long for communications between certain parts of the network.

In a Layer 3 (Link Layer) network, loop prevention is commonly achieved using a “Time to Live” or TTL field in a Layer 3 packet header. In each Layer 3 switch, this field is decremented, and a packet is discarded if TTL reaches zero. Layer 2 bridges cannot easily use this method, since the existing Layer 2 packet header does not include a TTL field.

To mitigate these limitations, “Shortest Path Bridging” is being defined at the IEEE (IEEE Working Group 802.1aq). Unfortunately, this protocol may not handle loop conditions as well as RSTP. Loops can occur for unacceptable periods of time especially if a network topology changes (for example, if a new bridge or link is added, or if there is a link failure).

Several methods have been proposed to solve this loop prevention issue for Layer 2 bridges:
Detect loops by counting how often a device connected to a network changes its port association;
Detect loops by sending various types of probe frames to individual ports;
Add a “Time to Live” field to Link Layer packets;
Analyze network load and determine that there is a loop if the load suddenly increases substantially or exceeds a certain threshold;
Limit the amount of Broadcast or Multicast packets sent on a port; and
Analyze received frames to detect duplicates, and determine there is a loop if the number of duplicates exceeds a threshold.

All these methods can have the disadvantage that a loop is only detected after a period of time, or after a predefined number of looped frames are received. However, especially with high-speed networks, even a loop duration of a few seconds or even milliseconds can result in millions of packets being looped, which in turn can cause network meltdown or result in overload of connected devices. In addition, some of the proposed methods are quite complex to implement. In some cases, data packet format changes would be required, making legacy device support difficult, if not impossible.

Therefore, there is a need for a loop detection method and apparatus that do not require changes in existing protocols or packet formats, that detects network loops reliably and rapidly, and that is relatively simple to implement.

### SUMMARY

In one embodiment, a method includes receiving an indicator that an packet has been received at a physical port of a bridge device within a network. The method also includes determining, in response to the indicator and based on a source address value associated with the packet, that an identifier of the physical port is not associated within a filter database with the source address value. A packet counter value associated with the physical port is changed in response to the determining.

In another embodiment, a method includes receiving a time indicator associated with a first packet in response to the first packet being received at a first physical port of a bridge device. The first packet is sent to the first physical port over a network from a portion of a network device associated with a media access control (MAC) address. The method also includes receiving a time indicator associated with a second packet in response to the second packet being received at a second physical port of the bridge device that is different than the first physical port. The second packet is sent to the bridge device over the network from the portion of the network device. A time period is calculated based on the time indicator associated with the first packet and the time indicator associated with the second packet. The second packet is dropped when the time period is less than a threshold time period.

In yet another embodiment, an apparatus includes a first physical port that is configured to receive a first packet from a portion of a network associated with a source address value. The apparatus also includes a second physical port configured to receive a second packet from a portion of a network associated with the source address value. The second packet is received at the second physical port after the first packet is received at the first physical port. The apparatus also includes a loop module configured to trigger disabling of the second physical port when a time period calculated based on a time indicator associated with receipt of the first packet at the first physical port and a time indicator associated with receipt of the second packet at the second physical port is less than a threshold period of time.

### BRIEF DESCRIPTION OF THE DRAWINGS

For a better understanding of the nature and objects of some embodiments of the invention, reference should be made to the following detailed description taken in conjunction with the accompanying drawings.

FIG. 1 is a schematic diagram that illustrates components within a layer 2 bridge device.

FIG. 2 is a schematic diagram that illustrates the format of a typical Ethernet packet.

FIG. 3 is a diagram that illustrates at least some content from a filter database associated with a bridge device.

FIG. 4 is a flowchart that illustrates a learning process, a loop detection process, and a forwarding process that can be executed at a bridge device such as that shown in FIG. 1.

FIG. 5A is a schematic graph that illustrates signal timing associated with a first port of a bridge device.

FIG. 5B is a schematic graph that illustrates signal timing associated with a second port of a bridge device.

FIG. 5C is a schematic graph that illustrates signal timing associated with a loop module of a bridge device.

### DETAILED DESCRIPTION

Embodiments of the invention are related to an apparatus and methods to detect loops within, for example, a link layer (layer 2) of a network. Advantageously, in some embodiments, if a determination is made that the packets may be related to a network loop, the packets can be removed from at least portions of the network or can be otherwise processed. These techniques can prevent or substantially prevent congestion in the network that would otherwise result from the looped packets. In some embodiments, the packets can be, for example, Internet Protocol (IP) packets (e.g., Ethernet packets).

To forward packets from a receive port (e.g., physical port of a bridge device where a packet is received) to a correct transmit (Tx) port (also can be referred to as an output port or a destination port), a link layer bridge device can be configured to maintain a media access control (MAC) address database or data structure, which can be referred to as a filter database or data structure. The receive port can also be referred to as a receiving (Rx) port or as a source port. The filter database can be configured to include a list of, for example, MAC addresses as well as the receiving port at which packets with a particular source address (SA) were received. To allow address management, a time indicator (e.g., a time stamp or a time value) indicating when the last packet from the receiving port was received can also be stored as well. Some implementations of the filter database can be configured to store associated virtual local area network (VLAN) identifiers (IDs) to enable per-VLAN bridging.

In some embodiments, after a packet is received at a receiving port, the bridge device (e.g., a loop module associated with the bridge device) can be configured to determine whether the packet's receiving port is in a learning state or a forwarding state, as defined by, for example, the Spanning Tree protocol. If the receiving port is not in a learning state or a forwarding state, the packet can be dropped.

In some embodiments, the bridge device can be configured to determine if a SA associated with the packet is already stored in the filter database. If an entry for the SA does not exist within the filter database, a new entry can be created. If an entry already exists within the filter database, the parameters associated with the entry (e.g., receive port identifier and time value) can be updated. This activity can be executed within a learning process by, for example, a learning module.

After the learning process is completed (e.g., executed), the bridge device can be configured to determine whether the receiving port of the packet is in a forwarding state. If not in a forwarding state, the packet can be dropped. If the receiving port is in the forwarding state, the bridge device can be configured to look up the packet's destination address (DA) within the filter database. If the DA is, for example, a multicast address or broadcast MAC address, the packet can be forwarded to all ports in a forwarding state except for the packet's receiving port. If the DA is included in the filter database, the bridge device can be configured to extract the associated port identifier (e.g., number) from the filter database. This port identifier can be the transmit port number for the given packet.

In some embodiments, the bridge device is configured to verify whether the transmit port identifier matches the receiving port identifier. If the port identifiers match, the packet can be discarded. In some embodiments, the bridge device can be configured to verify whether the transmit port is in a forwarding state. If the transmit port is not in a forwarding state, the packet can be discarded. If the transmit port is in a forwarding state, the packet can be forwarded to the transmit port.

To detect a network loop, the bridge device is configured, in some embodiments, to examine whether a SA associated with one or more packets received at the bridge device are included within the filter database of the bridge device. If an entry for the SA associated with the packet(s) is included in the filter database, an identifier associated with a receiving port (e.g., a port identifier) where the packet is received is compared against an identifier of a port where the packet is expected to be received. A physical port where the packet is expected can be referred to as the expected port. If the receive port identifier is matched with the expected port identifier in the filter database, the time value in the filter database can be updated with a time substantially corresponding with a time that the packet was received (i.e., receive time) at the bridge device (e.g., port of the bridge device), and the packet forwarding process can be executed as, for example, described above.

If the receive port identifier and the expected port identifier stored in the filter database do not match (e.g., are not associated within the filter database), in some embodiments, the bridge device is configured to identify this scenario as a potential loop condition. In some embodiments, a loop can be formed when multiple active network paths exist between two devices because of an improper logical link within a filter database (e.g., forwarding table) or inconsistent filter databases between the two devices. In some embodiments, packets can be repeatedly transmitted between more than two bridge devices within a network that form a loop. For example, a packet received at a physical port (expected port) of bridge A can be transmitted through bridges B and C, then back to another physical port (unexpected port) of bridge A. In some embodiments, a physical port of the bridge device can act as an entry point for a loop.

As a next operation of the loop detection process, in some embodiments, the packet's receive time is compared against the time value stored in the filter database. If the difference in time is less than (or equal to in some cases) a configurable or pre-determined threshold time period T1, the loop can be identified as a confirmed network loop, the packet is dropped, and/or a drop counter is changed (e.g., incremented). In some embodiments, if the drop counter is incremented and the drop counter value exceeds a second threshold value T2, the time value in the filter database is updated with a receive time of the packet, and the drop counter is reset. In some embodiments, the drop counter can be referred to as a packet counter.

In some embodiments, if the difference in time (e.g., different in time between that included in the filter database and receive time of the packet) exceeds the threshold time period T1, the bridge device can be configured to assume that a topology change (e.g., network topology change) has occurred. In this case, the entry in the filter database can be updated with the new receive port and the receive time of the packet, and the forwarding process can continue as, for example, described above.

Other functionality can include the ability to respond to events to manage the loop detection process. For example, in some embodiments, when a loop is detected, a notification that a loop has been detected can be sent to a specified entity (e.g., a network administrator). In some embodiments, a physical port associated with the loop is disabled for at least a specified period of time. For example, the physical port can be disabled until the loop condition is resolved.

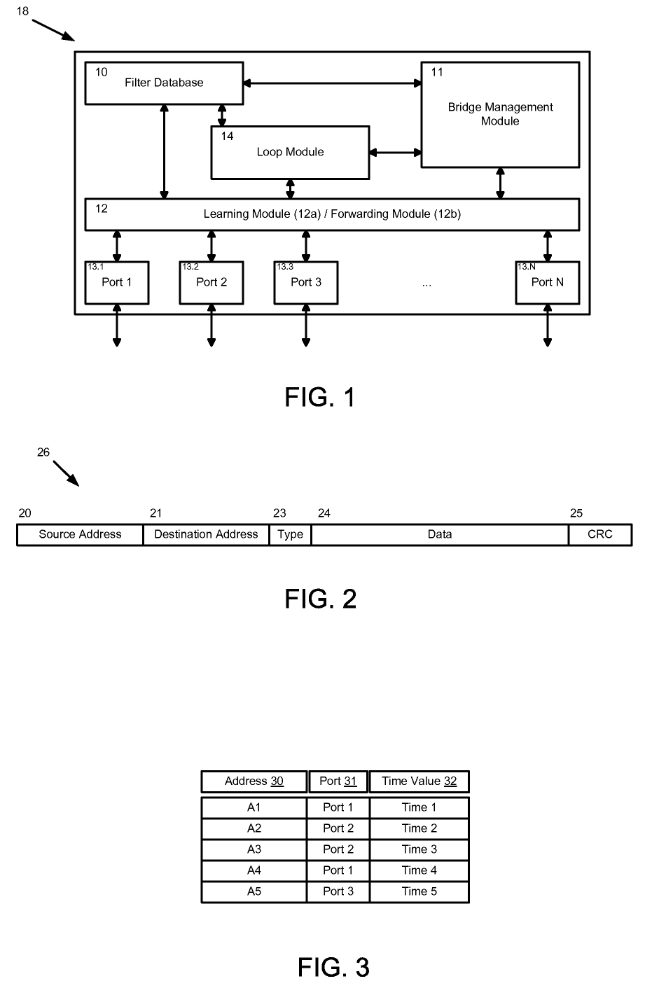

FIG. 1 is a schematic diagram that illustrates components within a layer 2 bridge device 18, according to an embodiment of the invention. As shown in FIG. 1, the bridge device 18 includes a learning module 12a, a forwarding module 12b, and a loop module 14. In some embodiments, the loop module 14 can be referred to as a loop detection module. The forwarding module 12b receives packets from ports 13.1, 13.2, . . . , 13.N. The forwarding module 12b is configured to access and use information stored in a filter database 10 so that the forwarding module 12b can determine whether a packet received at the bridge device 18 should be forwarded to, for example, a separate entity (not shown) over a network (not shown). If the forwarding module 12b determines that a packet received at the bridge device 18 should be forwarded, the forwarding module 12b can be configured to access information stored in the filter database 10 to determine the output port from which the packet should be sent and/or the ports to which the packet should be sent.

The learning module 12a can be configured to add a newly learned address (e.g., a source address learned from a packet received at the bridge device 18) into the filter database 10, and to update existing entries (e.g., update a time indicator associated with a port identifier included in the filter database 10). The bridge management module 11 can be configured to manage interactions (e.g., control signaling) between the components within the bridge device 18. In some embodiments, the bridge management module 11 can be configured to execute an aging process (e.g., aging operation or operations) to remove old addresses from the filter database 10 when they have become obsolete. For example, the bridge management module 11 can be configured to remove an entry from the filter database 10 if a time that the entry has existed within the filter database 10 exceeds a threshold time period.

The loop module 14 can be configured to detect a network loop. The loop module 14 can be configured to process packets received at the bridge device 18 in response to the network loop being detected. For example, the loop module 14 can be configured to trigger activities to prevent or substantially prevent (e.g., mitigate) packets from being transmitted within the network loop.

The modules illustrates in FIG. 1 can be software modules (e.g., computer code) and/or hardware modules (e.g., a processor or an application-specific integrated circuit (ASIC)). The modules can be associated with one or more processors (not shown) and/or memories (not shown). In some embodiments, the functions associated with the modules can be combined into one or more modules and/or separated into different modules (not shown).

FIG. 2 is a schematic diagram that illustrates the format of a typical Ethernet packet 26. Six bytes of the packet 26 correspond to a source address 20 of the packet 26. Another six bytes correspond to a destination address 21 of the packet 26. A bridge device can be configured to use the source address 20 to determine which port a specific address is associated with, and can be configured to use the destination address 21 to determine which port the packet 26 should be sent to. For example, learning module 12a from the bridge device 18 shown in FIG. 1 can be configured to parse the source address 20 from the packet 26 and can forward the packet 26 to a particular port identifier based on information stored in the filter database 10.

FIG. 3 is a diagram that illustrates at least some content from the filter database 10 associated with a bridge device (not shown). Each address 30 included in the filter database 10 is associated with a port 31 and a time value 32. The address 30 can be a source address and/or a destination address, and the port 31 can be a source port and/or a destination port. An address 30 can be, for example, an address value associated with a portion of a network device such as a MAC address associated with a network card. In some embodiments, address 30 can be a combination of an address such as a MAC address and an identifier associated with a VLAN.

The bridge device (such as that shown in FIG. 1) can be configured to learn a new address by, for example, storing information associated with a packet (such as that shown in FIG. 2) received at the bridge device. For example, the filter database 10 can be updated with an entry that includes the source address associated with a received packet, an identifier (e.g., number) associated with a port at which the packet is received, and a receive time.

As shown in FIG. 3, one or more address values 30 can be associated with a port 31 within the filter database. For example, address value A2 and address value A3 are both associated with port 2 in the filter database. Each address value 30, however, is not associated with more than one port 31. If an address value 30 is associated with more than one physical port 31, packets can be sent in loops between the multiple ports. Because each address value 30 is only associated with a single port 31, the bridge device can be configured to determine whether a packet received at the bridge device was received, with reference to the filter database, at the proper (i.e., expected) physical port.

For example, a bridge device can query the filter database based on the source address value included in the packet to determine whether or not the packet was received at a physical port where the packet should have been received. Specifically, if the source address included in a packet received at port 3 of the bridge device is A3, the bridge device can determine based on the filter database shown in FIG. 3 that the packet should have been received at port 2. In other words, port 2 would be the port expected to receive the packet.

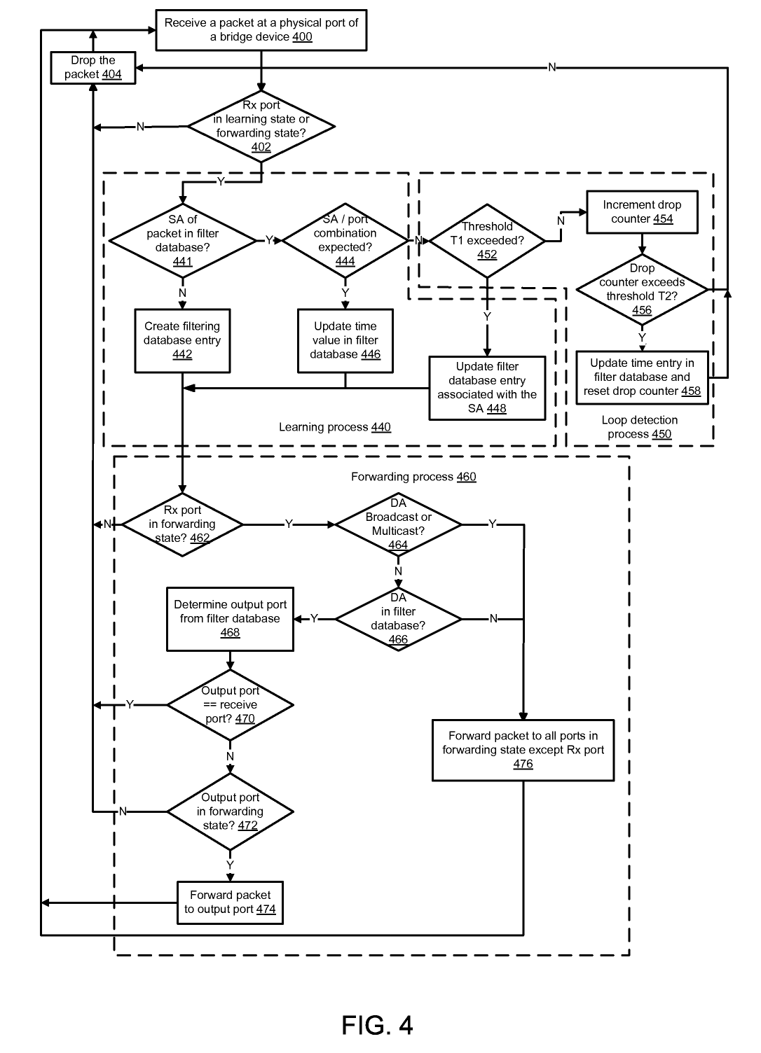

FIG. 4 is a flowchart that illustrates a learning process 440, a loop detection process 450, and a forwarding process 460 that can be executed at a bridge device such as that shown in FIG. 1. As shown in block 400 of FIG. 4, a packet is received at a port of the bridge device. The port where the packet is received can be referred to as the receiving port. The packet's destination address value, source address value, receive port identifier, and receive time can be determined. For example, the source address value and the destination address value can be obtained from the packet directly. The receive port identifier can be obtained, for example, based on information related to the port at which the packet is received. The time can be determined based on, for example, a clock associated with the bridge device and/or a network clock.

At block 402, a determination is made as to whether the receive port is in a learning state or a forwarding state. If the receive port is not in either the learning state or the forwarding state, the packet is dropped in block 404. If the receive port is in a learning state or a forwarding state, the source address associated with the packet is compared with entries in the filter database in block 441 to determine whether or not an entry associated with the source address exists in the filter database. If no entry that includes the source address exists in the filter database, a new entry associated with the source address is created in block 442.

If the source address value/port identifier combination associated with the packet is as expected (e.g., correct) as determined in block 444, the time value associated with the existing entry is updated as shown in block 446. The determination in block 444 can be made with reference to the filter database, which includes source address value/port identifier combinations (such as that shown in FIG. 3). If an entry for the packet's source address exists and the bridge device determines in block 444 that the source address value/port identifier combination associated with the packet is as expected (e.g., correct), the bridge device can be configured to update the time value in the filter database (shown in block 446). The time value can be, for example, a receive time associated with the packet (e.g., a time indicator that substantially corresponds with a time that the packet is received at the bridge device). After the time value has been updated in the filter database in block 446, packet processing can continue with the forwarding process 460.

If the entry related to the packet's source address exists in the filter database, but the expected receive port (i.e., the port stored in the filter database) does not match the packet's receive port (i.e., the port at which the packet was actually received) in block 444, the bridge device can be configured to identify this scenario as a potential loop condition. In other words, if the source address value/port identifier combination associated with the packet does not match source address value/port identifier combination included in the filter database at block 444, the packet is identified as a potentially looping packet. Packet processing can continue with the loop detection process 450.

In block 452 of the loop detection process 450 the packet's receive time is compared with the most recent receive time value stored in the filter database. If the time difference between the packet's receive time and the time value stored in the filter database exceeds a pre-determined threshold time period T1 in block 452 of the loop detection process 450, the bridge device can be configured to update the entry (e.g., port identifier, time value, address value) associated with source address in the filter database with the new receive port and the packet's receive time (block 448 of the learning process 440). In this case, it is assumed that either the sending device associated with the source address changed its location, or that the network was reconfigured (i.e., network topology has changed). Packet processing then continues with the forwarding process 460.

If the time difference compared in block 452 does not exceed the threshold time period T1, the packet is identified as a looping packet within a network loop (e.g., a network loop is detected). In some embodiments, the threshold time period T1 can be, for example, 1 to 5 seconds. The threshold time period T1 can be defined by (e.g., configured by), for example, a network administrator. In some embodiments, the threshold time period T1 can be less than the amount of time typically required to implement (e.g., propagate) a change in a topology of a network associated with the bridge device. In other words, the threshold time period T1 is defined so that when the threshold time period T1 is exceeded, it can be assumed that a change in network topology has been made (as discussed above in connection with block 448).

To mark the loop, a per-port loop drop counter is incremented in block 454. If the incremented loop drop counter exceeds a second threshold T2 (e.g., a drop counter threshold value) in block 456, the time value in the filter database is updated with the packet's receive time, and the loop drop counter is reset to zero (block 458). The packet can subsequently be dropped in block 404. If the drop counter has not been exceeded in block 456, the packet is dropped in block 404, and the loop detection process 450 is complete. In some embodiments, the drop counter threshold value can be, for example, approximately 1000. The drop counter is referred to as a per-port drop counter because it is associated with the physical port involved in the network loop. In some embodiments, if multiple network loops are detected, separate drop counters can be associated with each physical port associated with each network loop.

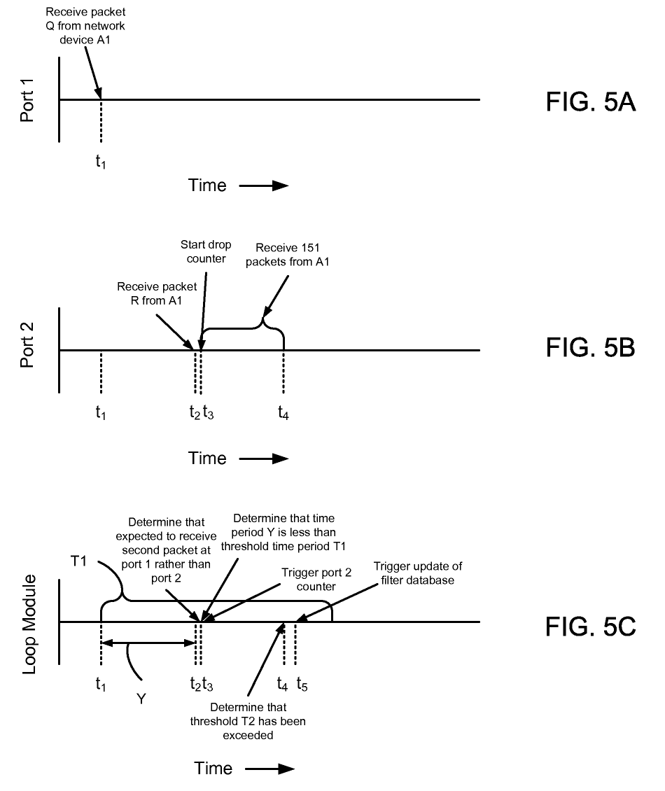

The drop counter can be defined to substantially ensure that individual packets looping through the network for a long time are detected and removed reliably even if the network loop exists for a long period of time. If the drop counter threshold value is defined at a value that is too high (e.g., 100,000), the threshold time period T1 may be exceeded in block 452 based on receive times associated with subsequent packets received at the bridge device and the filter database may be updated in block 448 with erroneous information. If the drop counter threshold value is defined at a value that is too low (e.g., less than 10), the time entry in the filter database may be updated too frequently in block 458 and packets may be incorrectly identified as looping packets. This could occur because the time difference between the time value stored in the filter database (which would be frequently updated in response to the low threshold value T2) and the receive times of packets would fall below the threshold time period T1. More details related to loop detection timing are discussed in connection with FIG. 5.

Any of the operations in blocks 452, 454, 456, or 458 can optionally include creation of (e.g., trigger) an event (e.g., a triggering signal or a notification) to a management process, which can be used to inform a controlling instance about the presence of a loop. This event might then be used for further activity, such as an alert to an administrator, another network device (e.g., broadcast a message), or to disable affected bridge device ports for a period of time.

In some embodiments, for example, based on the time difference between the time value stored in the filter database and the receive time of the packet in block 452, the physical port associated with the network loop can be disabled (e.g., temporarily disabled). In some embodiments, the physical port can be disabled for only a specified period of time and then enabled. In some embodiments, the physical port can be disabled until a determination has been made (e.g., by the bridge device or by a different network device in communication with the bridge device) that the network loop no longer exists, or was erroneously detected. In some embodiments, packets sent to the disabled port of the bridge device can be dropped.

In some embodiments, during the disabled time period, packets can still be received at the physical port, and can be held in, for example, a buffer. If the bridge device later determines (or is notified by a different network device) that the network loop was erroneously detected, the packets held in the buffer can be forwarded using, for example, the forwarding process 460 shown in FIG. 4.

In some embodiments, the physical port associated with the network loop can be disabled until a threshold period of time T3 has been exceeded. After the threshold period of time T3 has been exceeded, the bridge device can be configured to notify higher level protocols (e.g., network devices operating based on a higher level OSI protocol than the bridge device) that a network loop exists.

Referring now to the forwarding process 460, if the receive port is not in a forwarding state as determined in block 462, the packet is dropped in block 404. In blocks 464 and 466, the destination address is used to determine the output port for the packet received at the bridge device. If the destination address is a broadcast or multicast address (block 464), or if there is no entry for the destination address in the filter database (block 466), the packet is forwarded to all ports in forwarding state except for the receive port (block 476). If an entry for the destination address exists in the filter database (block 466), the output port is determined based on the filter database in block 468. In block 470, the bridge device compares the output port with the receive port. If the ports are the same, the packet is dropped (block 404). Otherwise, the bridge device determines in block 472 if the output port is in a forwarding state. If the output port is in the forwarding state, the packet is sent to the output port in block 474. Otherwise, the packet is dropped in block 404.

FIG. 5 is a schematic diagram that illustrates signal timing associated with a first port of a bridge device (port 1 shown in FIG. 5A), a second port of a bridge device (port 2 shown in FIG. 5B), and a loop module (shown in FIG. 5C). In each of the figures associated with FIG. 5, time increases to the right. The time values (e.g., time t₁) shown in FIG. 5 are for illustrative purposes and are not necessarily drawn to scale. The timing diagrams associated with FIG. 5 are based on the flowchart shown in FIG. 4.

As shown in FIG. 5A, at time t₁ a packet Q is received at port 1 from network device A1. In some embodiments, the network device A1 can be, for example, a portion of a network device such as a network card and can be uniquely associated with an address value such as a MAC address value. In this embodiment, port 1 is the physical port at which packets from network device A1 are expected to be received (as can be recorded within a filter database). Although not shown, at time t₁, the receive time of the packet Q can be stored in the filter database and associated with an address value associated with network device A1 because packet Q was received at the proper physical (port 1) of the bridge device.

As shown in FIG. 5B, at time t₂, a packet R is received from network device A1 at port 2 of the bridge device. As shown in FIG. 5C, in response to the packet R being received at time t₂, the loop module determines that packet R is received at a different physical port (port 2) than expected by the loop module at time t₃. Also as shown in FIG. 5C at time t₃, a determination is made by the loop module that time period Y is less than the threshold time period T1. The time period Y is the difference between the time value associated with packet Q (recorded in the filter database) and the time value associated with the receipt of packet R. In response to these determinations, a drop counter associated with port 2 is triggered by the loop module at time t₃. The drop counter start time is also shown in FIG. 5B. In this embodiment, the drop counter threshold value T2 is 150.

As shown in FIG. 5B, between times t₃ and t₄, 151 packets are received at port 2 from network device A1. The loop module determines (shown in FIG. 5C) at time t₄ that the counter threshold value T2 of 150 has been exceeded. In response to the determination by the loop module at time t₄, the loop module in this embodiment is configured to trigger an update of the filter database. The filter database can be updated based on, for example, the received time of packet number 151 received at approximately time t₄.

Although not shown, in some embodiments, the loop module can be configured to disable, at least temporarily, port 2 starting at or any time after, for example, time t₃ when the potential loop condition is first detected. Also, although not shown, in some embodiments, the loop module can be configured to send at any time after time t₃ when the potential loop condition is first detected one or more notifications that a loop condition exists.

A practitioner of ordinary skill in the art requires no additional explanation in developing the embodiments described herein but may nevertheless find some helpful guidance by examining the following references, the disclosures of which are incorporated by reference in their entireties:
U.S. Pat. No. 6,219,739 (Spanning tree with fast link-failure convergence);
U.S. Pat. No. 6,202,114 (Spanning tree with fast link-failure convergence);
US 2005/0220036 (Layer 2 loop detection system);
US 2006/0013141 (Loop frame detecting device and method for detecting loop frame);
US 2006/0013143 (Network looping detecting);
US 2006/0072460 (Loop connection detecting method and device);
US 2006/0126517 (Loop detection method and device);
US 2006/0133286 (System and method for detecting loops in a customer-provider bridge domain);
US 2006/0285499 (Loop detection for a network device);
U.S. Pat. No. 6,298,456 (Runtime detection of network loops);
U.S. Pat. No. 6,857,027 (Intelligent network topology and configuration verification using a method of loop detection);
U.S. Pat. No. 6,950,870 (Method and apparatus for loop detection and dissolution in a communication network);
IEEE802.1D-2004 (IEEE Standard for Local and metropolitan area networks: Media Access Control (MAC) Bridges); and
Radia Perlman, Interconnections: Bridges, Routers, Switches, and Internetworking Protocols (2^{nd} Edition), Chapter 3.

An embodiment of the invention relates to a computer storage product with a computer-readable medium having computer code thereon for performing various computer-implemented operations. The term “computer-readable medium” is used herein to include any medium that is capable of storing or encoding a sequence of instructions or computer codes for performing the operations described herein. The media and computer code may be those specially designed and constructed for the purposes of the invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as ASICs, programmable logic devices (“PLDs”), and ROM and RAM devices. Examples of computer code include machine code, such as produced by a compiler, and files containing higher level code that are executed by a computer using an interpreter. For example, an embodiment of the invention may be implemented using Java, C++, or other object-oriented programming language and development tools. Additional examples of computer code include encrypted code and compressed code. Moreover, an embodiment of the invention may be downloaded as a computer program product, which may be transferred from a remote computer (e.g., a server computer) to a requesting computer (e.g., a client computer or a different server computer) by way of data signals embodied in a carrier wave or other propagation medium via a transmission channel. Accordingly, as used herein, a carrier wave can be regarded as a computer-readable medium. Another embodiment of the invention may be implemented in hardwired circuitry in place of, or in combination with, machine-executable software instructions.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A method, comprising:
receiving a time indicator associated with a first packet in response to the first packet being received at a first physical port of a bridge device, the first packet being sent to the first physical port over a network from a portion of a network device associated with a media access control (MAC) address;
receiving a time indicator associated with a second packet in response to the second packet being received at a second physical port of the bridge device, the second packet being sent to the second physical port of the bridge device over the network from the portion of the network device, the second physical port being different than the first physical port;
calculating a time period based on the time indicator associated with the first packet and the time indicator associated with the second packet; and
dropping the second packet when the time period is less than a threshold time period.

2. The method of claim 1, further comprising:
changing a packet counter value associated with the second physical port in response to the calculating.

3. The method of claim 1, wherein the time indicator associated with the first packet is included in a filter database,
the method further comprising:
receiving a time indicator associated with a third packet in response to the third packet being received at the second physical port of the bridge device, the second packet being received at the second physical port of the bridge device before the third packet is received at the second physical port of the bridge device; and
changing a packet counter value associated with the second physical port in response to the receiving the time indicator associated with the third packet.

4. The method of claim 3, further comprising:
replacing the time indicator in the filter database with the time indicator associated with the third packet when the packet counter value satisfies a threshold condition in response to the changing.

5. The method of claim 1, wherein an identifier associated with the first physical port is associated with the MAC address within a filter database,
the method, further comprising:
determining that an identifier associated with the second physical port is not associated with the MAC address within the filter database, the dropping includes dropping in response to the determining.

6. The method of claim 1, wherein the time indicator associated with the second packet is defined based on a time that the second packet is received at the second physical port of the bridge device,
the method further comprising:
sending, to a system administrator associated with at least a portion of the network, a notification that a loop condition exists in response to the calculating.

7. The method of claim 1, further comprising:
sending a notification that a loop condition exists in response to the calculating, the sending includes sending to an open systems interconnection layer higher than layer 2.

8. A method, comprising:
receiving an indicator that a packet has been received at a physical port of a bridge device within a network;
determining, in response to the indicator and based on a source address value associated with the packet, that an identifier of the physical port is not associated within a filter database with the source address value; and
changing a packet counter value associated with the physical port in response to the determining.

9. The method of claim 8, wherein the changing includes changing when a time period calculated based on a time indicator associated with the packet and a time indicator associated with the source address value within the filter database is less than a threshold time period.

10. The method of claim 8, wherein the physical port is a first physical port, the source address value is associated within the filter database with an identifier of a second physical port of the bridge device and with a time value,
the method, further comprising:
modifying the time value when the packet counter value satisfies a threshold condition in response to the changing.

11. The method of claim 8, further comprising:
dropping the packet in response to the determining.

12. The method of claim 8, further comprising:
disabling the physical port for a specified period of time in response to the determining.

13. The method of claim 12, further comprising:
holding a plurality of packets at the bridge device in response to the determining, the packet being included in the plurality of packets.

14. The method of claim 8, wherein the source address value is a media access control (MAC) address value, the packet is received at the physical port from a portion of a network device associated with the MAC address value.

15. The method of claim 8, wherein the source address value is associated with a virtual local area network (VLAN) identifier.

16. An apparatus comprising:
a first physical port configured to receive a first packet from a portion of a network associated with a source address value;
a second physical port configured to receive a second packet from the portion of a network associated with the source address value, the second packet being received at the second physical port after the first packet is received at the first physical port; and
a loop module configured to trigger disabling of the second physical port when a time period calculated based on a time indicator associated with receipt of the first packet at the first physical port and a time indicator associated with receipt of the second packet at the second physical port is less than a threshold period of time.

17. The apparatus of claim 16, wherein the threshold period of time is a first threshold period of time, the loop module is configured to trigger sending of a notification when the second physical port has been disabled for more than a second threshold period of time.

18. The apparatus of claim 16, further comprising
a filter database operably coupled to the loop module, the time indicator associated with the first packet is accessed from the filter database by the loop module.

19. The apparatus of claim 16, wherein the loop module is configured to enable the second physical port in response to a determination that a loop condition does not exist.

20. The apparatus of claim 16, wherein the loop module is configured to change a packet counter value associated with the second physical port in response to the time period being less than the threshold period of time.
